(19) United States
(12) Patent Application Publication
(10) Pub. No.: US 2009/0183259 A1
(43) Pub. Date: Jul. 16, 2009

(54) Integrated Protection Service System Defining Risk Profiles for Minors

(76) Inventors: Jeffrey L. Rinek, Rescue, CA (US); Chistopher J. Hopkins, Auburn, CA (US); Winthrop D. Childers, San Diego, CA (US)

Correspondence Address: WINTHROP D. CHILDERS, 9855 FOX VALLEY WAY, SAN DIEGO, CA, 92127, US

(21) Appl. No.: 12/344,475

(22) Filed: Dec. 27, 2008

Related U.S. Application Data
(60) Provisional application No. 61/020,526, filed on Jan. 11, 2008.

(51) Int. Cl. G06F 21/00

(52) U.S. Cl. 726/23

(57) ABSTRACT

A system and method for protecting minors from various threats including adult predators is provided. The system and method include an integrated protection service system having monitoring and analysis functions. The system is configured to automatically monitor a reporting source that provides an input indicative of potential risks to the minor. The system is also configured to automatically analyze the input to determine a risk profile for the minor.

### RELATED APPLICATIONS

This non-provisional patent application claims priority to U.S. Provisional Application Ser. No. 61/020,526, Entitled “Integrated Protection Service Defining Risk Profiles for Minors”, filed on Jan. 11, 2008, incorporated herein by reference under the benefit of U.S.C. 119(e).

### FIELD OF THE INVENTION

The present invention concerns a service dedicated to protecting minors from various threats. More particularly, the present invention concerns a way of identifying and responding to threats that may at least partly be indicated by a minor's internet activities.

### BACKGROUND

Minors have always faced threats to their safety and well being including internal and external threats. Internal threats include accidents, depression/suicide, and self-inflicted harm. External threats include abductions, assaults, and sexual offenders. With the advent of the internet and other societal changes, many of these threats appear to be getting more numerous.

For example, “internet predators” or adults that try to seduce minors using the internet have become widespread. Some of these predators are very sophisticated and hard to detect or identify. In many households, unsupervised children use the internet and are exposed to these criminals.

Along with these threats minors, particularly teenagers, experience severe depression. This can cause a minor to be more susceptible to the approach of predators or to attempted suicide or acts of violence.

Generally speaking, parents of minors do their best to interact with and train minors in a way that minimizes the threats and teaches them to avoid them. Unfortunately, in some households with single parents or with both parents employed, sufficient time to monitor and interact with minors may be lacking. What is needed is a way to help even preoccupied parents protect minors from external and internal threats.

### BRIEF DESCRIPTION OF THE FIGURES

FIG. 1 depicts an integrated protection service of the present invention and its relationship to guardians or parents, law enforcement, and the center for missing and exploited children.

FIG. 2 depicts the functions or segments of the integrated protection service of the present invention.

FIG. 3 depicts a method of the present invention in flow chart form.

FIG. 4 depicts an integrated protection service system that may form a portion of the present invention in block diagram form.

FIG. 5A depicts various portions of an integrated protection service system.

FIG. 5B depicts an analytical module that is a portion of the integrated protection service system.

FIG. 6 depicts a method of analyzing a minor's internet and/or other system usage and issuing alerts when warranted.

FIG. 7 depicts a method of defining clusters using the integrated protection service system.

FIG. 8 depicts statistical clusters based upon information gathered from minors.

FIG. 9 depicts a method of fitting input information from a minor to a statistical cluster.

### DETAILED DESCRIPTION OF THE PREFERRED EMBODIMENTS

The foregoing refers to “minors” and “children”, and such terms refer to humans that are less than 18 (eighteen) years of age. As such, the terms “minors” and “children” are interchangeable in the context of the present invention. Also, the terms “parents” and “guardians” are used to refer to adults having minors in their care and hence will be interchangeable in the context of the present invention.

The foregoing refers to “sexual offenders”, “internet predators”, “preferential sex offenders”, and “sexual predators”. In general, these are all adults that pose a substantial risk to minors and often utilize the internet to victimize minors. The present invention applies to protecting children from all such adults.

The present invention also applies to protecting children from other threats such as the potential risks of depression or from other children that may pose a threat. The present invention applies to all threats for which the service and/or system of the present invention may be beneficial.

The present invention and its embodiments include and enable an integrated protection service that protects minors from aforementioned threats. Additionally, that children experience crises in other areas of their lives, such as school, friends, etc., can also be identified as a collateral benefit to this invention. This integrated protection service is unique in that it may include highly synergistic functions such as training, consulting, set-up, monitoring, analysis, and response. This service enables preoccupied parents to act proactively against threats to their children before those threats reach a critical threshold.

One important aspect of the present invention concerns the establishment of a “risk profile” for a minor. A risk profile is indicative of whether a minor faces an elevated degree of risk, the degree of that risk, and the type of that risk.

One risk profile can be called a “normal” or “non-elevated” risk profile. A non-elevated risk profile does not indicate zero risk but would indicate that there is no single risk that appears to be very unusual or elevated for a child. Thus, this may be indicative of the risk level for a typical child.

An elevated risk profile is indicative of the type, magnitude, and urgency of an elevated risk to a minor. The type of risk may be one or more of suicide/depression risk, adult offender risk, substance abuse risk, dangerous peer pressure risk, to name a few examples.

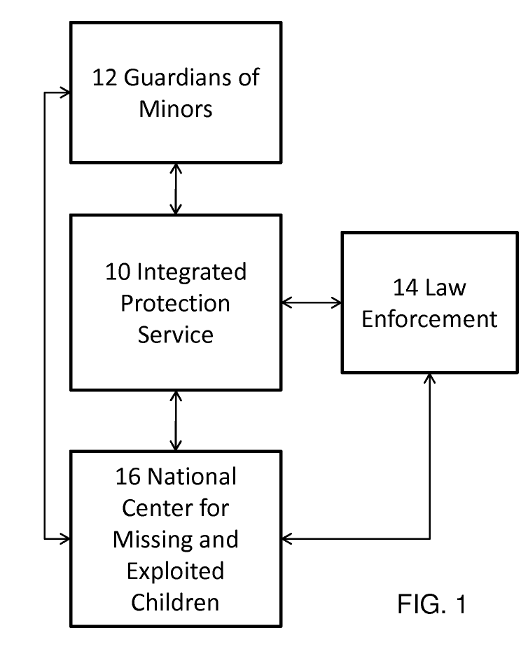

A service according to the present invention is depicted in block diagram form in FIG. 1. IPS (integrated protection service) 10 is in communication with guardians or parents of minors 12, law enforcement 14, and other organizations such as the NCEMC (national center for exploited or missing children) 16. As may be appreciated, IPS 10 may be in communication with additional organizations as well.

IPS 10 works with and communicates with parents or guardians 12 to detect areas of concern that may affect minors or children. IPS 10 works with law enforcement 14 to enable apprehension of adults who pose threats to minors. IPS 10 works with the NCEMC 16 to share database information and to identify individuals who are approaching minors in a potentially illegal or threatening way.

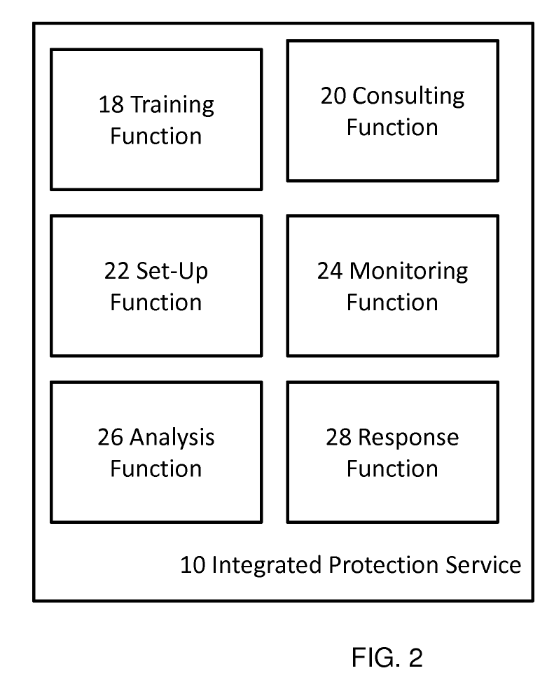

FIG. 2 depicts IPS (integrated protection service) 10 in block diagram form, illustrating various functions or segments of IPS 10. Functions or segments may include training 18, consulting 20, set-up 22, monitoring 24, analysis 26, and/or response 28. Descriptions of these segments follow although it is to be understood that functions of the segments may be overlapping and that this description of the segments is an exemplary embodiment of the invention.

Training segment 18 provides initial training for parents or guardians of minors. Segment 18 trains parents or guardians as to the dangers facing minors including internet predators, sexual exploitation, abductions, and depression to name a few. The training segment 18 helps guardians to identify signs of these threats and actions to take when threats are observed. The training segment 18 also trains guardians how to use internet monitoring software and how to work with the various segments of IPS and other organizations to assure protection of the minors under their care.

Consulting segment 20 provides consulting related to the specific concerns a parent may have. When a parent initially engages IPS 10, the consulting segment 20 may listen to specific concerns parents may have concerning their child. Consulting segment 20 then may customize any or all functions of IPS 10 pursuant to those concerns. Consulting segment 20 also provides consulting to parents for concerns or observations that may arise while the parents engage IPS 10.

Set-up function 22 provides parents with materials, information, software, and assistance for monitoring their children. Set-up function 22 may also help parents with software installation and other tasks involved in establishing engagement with IPS 10. In particular, set-up function initiates monitoring of a minor's internet activities.

Once parents have engaged IPS 10, monitoring and observing their child's activities may be primarily their responsibility. The most important factor for child safety is the presence of committed and involved parents. At the same time, monitoring segment 24 may also provide direct monitoring of a child's on-line and other activities. Monitoring function may provide this monitoring by gathering information from one or more “reporting sources”. Examples of reporting sources include the subject child, the child's family, the child's friends, the child's school, the child's classmates, law enforcement, social services, a government entity, or from the computer the subject child uses. More details of reporting sources and types of inputs received are discussed infra.

Analysis function 26 takes inputs or information from the reporting sources and creates a risk profile for the subject child. This risk profile may be computer generated or it may be assembled manually by a professional within the IPS 10. The risk profile is indicative of the type and magnitude of risks for the child.

Response function 28 responds to a risk profile or an update of a risk profile for a given child. When the risk profile is indicative of a sufficiently high risk to a child, the response function may respond by contacting the parents 12, law enforcement 14, or another entity such as NCMEC 16.

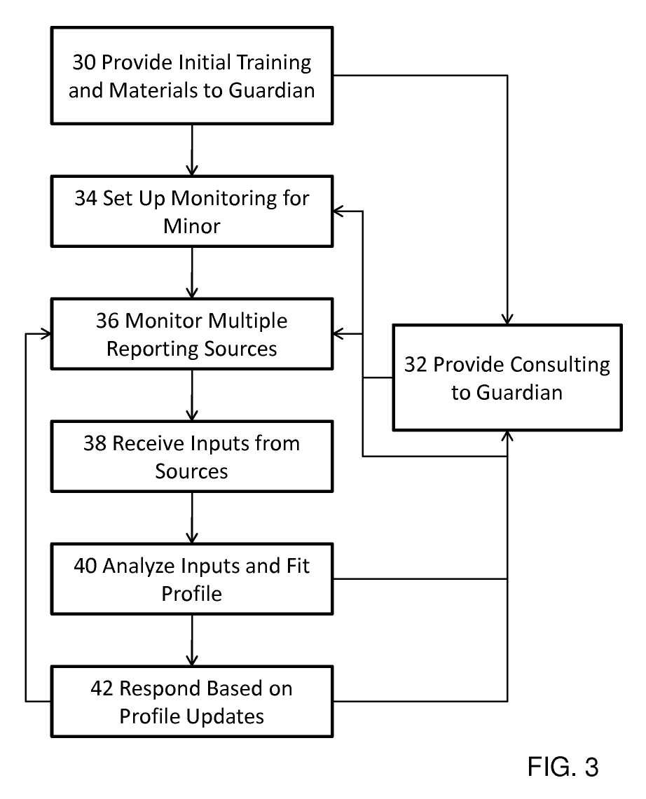

A method according to the present invention is depicted in flow chart form in FIG. 3. According to 30, IPS 10 provides initial training and materials to a parent or guardian of minors. These materials may include monitoring software and printed training materials for example.

During initial training, parents will learn about risks to their children, how to monitor a child's behavior, what elevated risk indicators to look for, and how to respond to the indications of elevated risk. As part of this training, parents may learn about the behavior and typology of preferential sex offenders so that they will be able to recognize threats and when to seek help. Parents may also be provided training and information concerning high risk teen or minor behavior.

According to 32, consulting is provided to parents. This may occur initially during training and may include having the parents describe their concerns to IPS 10 consultants. For example, a parent may describe their child's self-destructive behavior to an IPS 10 consultant. The consultant will then provide the parents with advice and a monitoring and response plan that specifically addresses this concern.

According to 34, monitoring is set up. This may include installation and activation of internet monitoring software. According to 36, one or more reporting sources are monitored. This includes monitoring of the internet activity according to software installed during step 34. According to 38, inputs from various reporting sources are received by IPS 10.

According to 40, inputs from monitoring software and/or other reporting sources are analyzed and a risk profile is determined. In one embodiment, the risk profile is based on statistical clustering technology. In one embodiment, the risk profile is based upon a manual evaluation of the inputs. Based upon elevated risks indicated by the risk profile, IPS 10 may provide consultation to parents according to 32.

According to 42, IPS responds to a new or updated risk profile. This may include closer scrutiny of a child's activity is suspicious behavior is detected. If the risk is high enough, the NMEC 16 or law enforcement 14 may be contacted.

In one embodiment, an alarm or an alert is issued according to 42. The alarm may alert parents, law enforcement, or others according to an elevated risk profile. The alert may come in the form of a manual or automated phone call, a text message, an email, or an instant message to name a few examples.

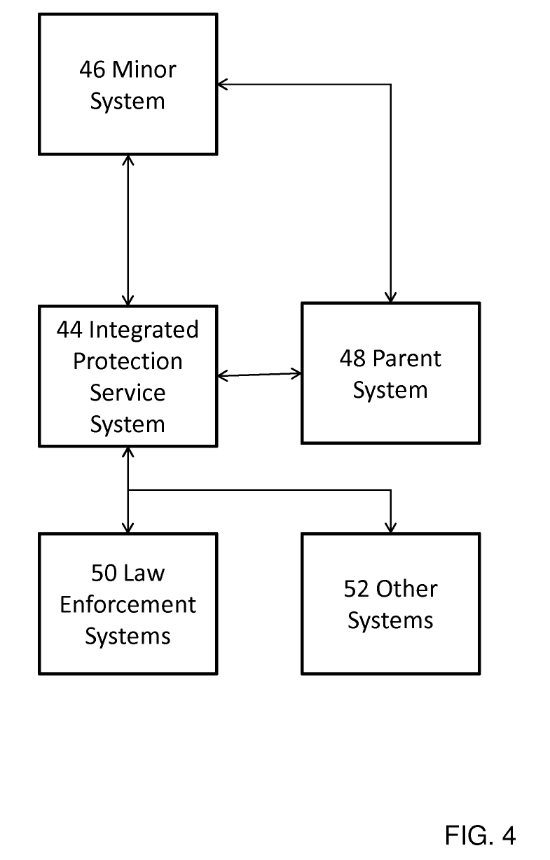

IPS (integrated protection service) may include an IT (information technology) system 44 that provides any or all of the functions depicted in FIG. 2. According to FIG. 4, IPS 10 includes an IPSS (integrated protection service system) 44 that is linked into various other IT systems or computers or telephones or cellular phones or other electronic devices including a minor system 46, a parent system 48, a law enforcement system 50, and a other systems 52 such as a NCMEC system.

IPSS 44 may be configured to directly monitor a child's internet activity by receiving information from minor system 46. IPSS 44 may also be configured to communicate concerns, monitoring results, and other information to and from parent system 48. IPSS 44 may also be configured to communicate information to and from police systems 50 and other systems 52.

Minor system 46 may be a personal computer utilized by the child. It may also be a cellular phone 46, a laptop 46, a palm computer 46, a personal digital assistant 46, or any other device used by a minor that can couple to a computer network, a cellular phone network, or any other wired or wireless communication system. Parent system 48 may be a personal computer 48, a cellular phone 48, a land telephone 48, a laptop computer 48, or any other electronic information related device 48 utilized by parents or guardians.

In a preferred embodiment, the computer and internet usage information indicative of the use of child system 46 is transmitted to parent system 48 and to IPSS 44. The parents can contact IPS 10 in the event that activity is seen that generates concern. At the same time, the usage information is securely stored within IPSS 44. IPSS 44 is configured to securely store the usage information in case the child system 46 or parent system 48 becomes compromised. As part of this preferred embodiment, IPSS 44 is configured to analyze the usage information to determine whether there is a cause for concern. If there is a cause for concern, IPSS 44 is configured to send an alert to parent system 48. In a preferred embodiment, IPSS is configured to communicate alerts to multiple devices including two or more of a cellular phone, a land telephone, a laptop computer, a personal digital assistant, a parent system 48, a law enforcement system 50, other systems 52 or any electronic system that is coupled to a network.

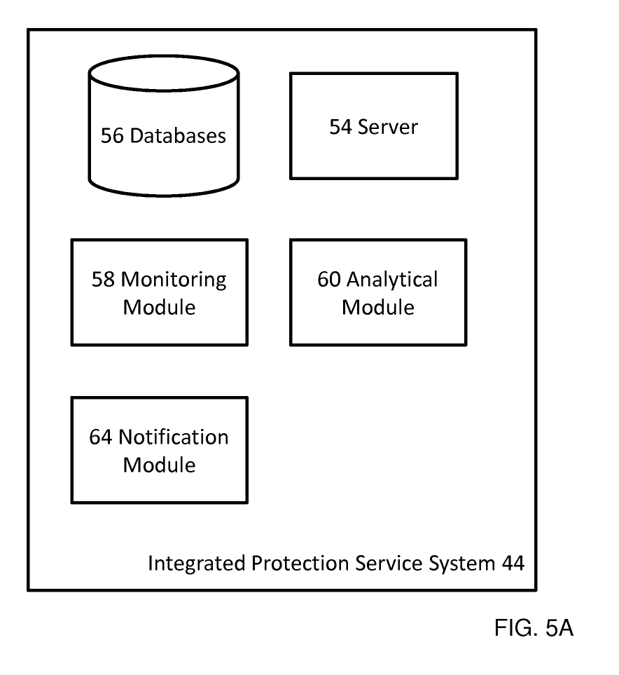

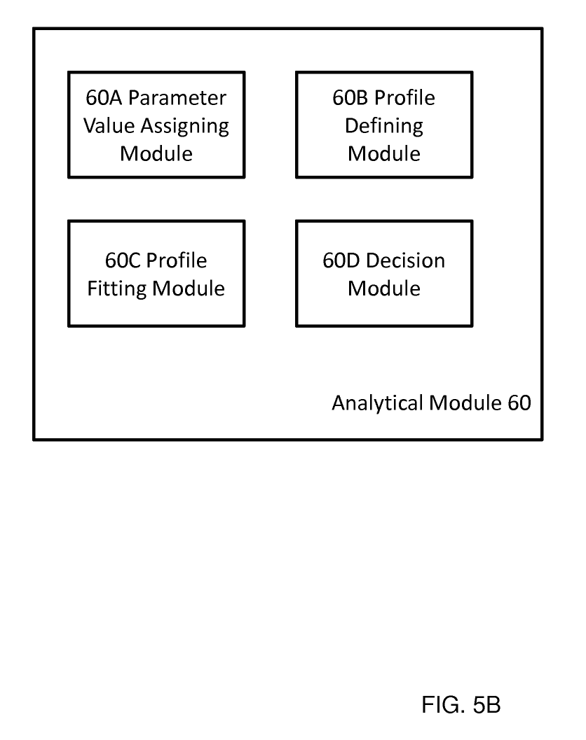

FIG. 5A depicts an exemplary IPSS 44 including server 54, databases 56, and software modules 58, 60, and 64. Server 54 is configured to manage communication between IPSS 44 and other IT systems. There may be other components and functions of IPSS 44 in addition to what is described herein. For example, IPSS 44 may include remote computers, laptops, palmtops, cellular phones, or other devices that are configured to communicate with server 54.

Database 56 stores information such as information from various reporting sources and risk profiles for minors. Database 56 may also store information received from law enforcement systems 50 and other systems 52 indicative of characterizations related to various offenders or suspects that may be pertinent to identifying threats to minors. Database 56 may also store the latest information that enables more effective analysis of potential or existing threats or elevated risk profiles. In a preferred embodiment, database 56 is configured to store internet and other usage information indicative of the record of a minor's use of minor system 46.

Monitoring module 58 is configured to receive information or inputs from various reporting sources and to store that information in database 56. Analytical module 60 is configured to analyze the inputs, identify risk profiles for minors, and make decisions as to what action to take for each profile. One decision may be to issue an alert in the event of an elevated risk profile.

Notification module 64 is configured to issue alerts to one or more of a plurality of devices. Such devices can include one or more of a land telephone, a cellular telephone, a personal digital assistant, a personal computer, a laptop computer, or any other fixed or portable electronic device that is coupled to a wired or wireless network.

FIG. 5B depicts an exemplary embodiment of analytical module 60 including a parameter value assigning module 60A, a profile defining module 60B, a profile fitting module 60C, and a decision module 60D. It is to be understood that analytical module 60 may contain one or more of modules 60A-60B.

Parameter value assigning module 60A defines parameter values based upon the inputs received by monitoring module 58. Parameter values are quantities that can be used by other modules such as profile defining module 60B, profile fitting module 60C, and/or decision module 60D. Parameter assigning module 60A quantifies and/or normalizes the inputs such that they are useful in subsequent processing by any or all of modules 60B-D.

In one alternative embodiment of IPSS 44, inputs received by monitoring module 58 are already quantified and normalized so that there is no need for parameter assigning module 60A. In another alternative embodiment, some inputs received by monitoring module 58 are quantified and normalized but others need to be quantified and normalized by parameter assigning module 60A.

Profile defining module 60B is configured to correlate inputs to risk profiles using data for which the risk profiles are known. This allows the use of profile fitting module 60C that utilizes inputs or parameter values for a given minor and identifies the most likely risk profile for that minor. In a preferred embodiment, profile defining module 60B continues to update definitions of risk profiles as more parameter value data becomes available in order to increase confidence of the correlation between particular risk profiles and the parameter values. In a preferred embodiment, analytical module 60 contains multiple risk defining modules using different means for defining risk profiles.

In one embodiment, profile defining module 60B is a cluster defining module configured to take inputs and/or parameter values from reporting sources for a multiplicity of minors and to fit that information to data clusters or statistical clusters. An exemplary statistical clustering technique is referred to a “K-means” clustering method, although there are other statistical clustering methods. These clusters may then be used to define various normal and elevated risk profiles.

Then, for a particular minor, the profile fitting module 60C may fit the parameter values for a given minor to a statistical cluster that has been determined by profile defining module 60B. The selected statistical cluster will then be indicative of a particular risk profile.

In one embodiment, profile fitting module 60C identifies a profile based on one or more parameter values clearly identifying a risk profile that does not require statistical fitting to a statistical cluster. As an example, an input indicating that a minor is engaging in “cyber-sex” would immediately indicate an elevated risk profile warranting further action. On the other hand, this input could be part of a statistical cluster analysis that indicates a particular risk typology.

In a preferred embodiment, analytical module 60 includes multiple different profile fitting modules 60C that operate using different methods of correlating parameter values to risk profiles. Each of these may correspond to a different profile defining module. Thus, parameter values for a given minor can be processed using multiple different analytical methods. This will tend to increase the chance of identifying risks and in confidence of results.

For each minor, decision module 60D is configured to determine an appropriate response for a given risk profile. In one embodiment, the decision module 60D activates the notification module 64 in response to identifying one or more elevated risk profiles. In response to the activation, the notification module sends an alert to various electronic devices for communicating to parents, grandparents, guardians, law enforcement authorities, or other parties that can take actions in response to the risk.

The type, magnitude, and urgency of the risk defined by the risk profile will determine the content and destinations of the alert. When there is a high risk and imminent danger, the alert destinations may include a plurality of electronic devices and be in the various forms including voice and text.

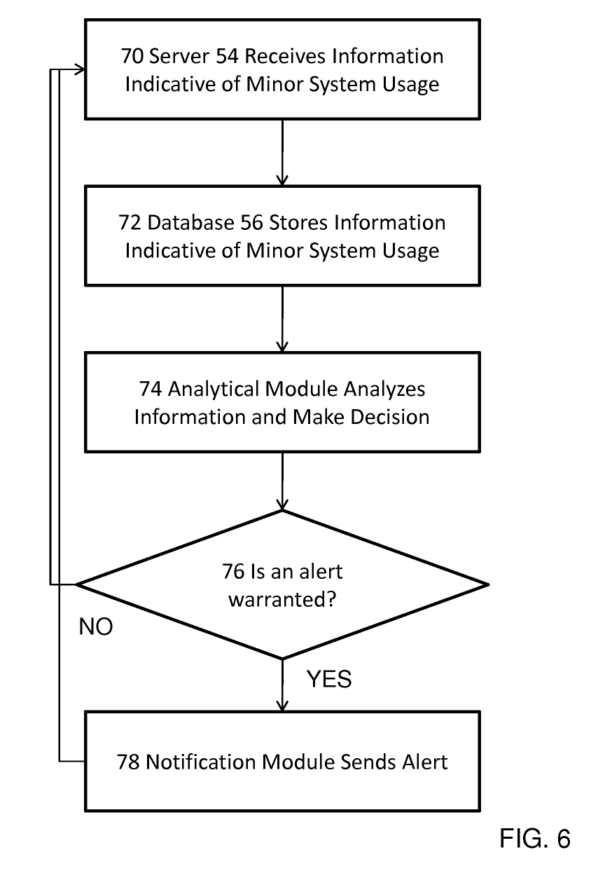

FIG. 6 depicts an exemplary operation of IPSS 44. According to 70, server 54 receives information indicative of the usage of a minor system 46. Minor system 46 may be a personal computer, a laptop computer, a cellular phone, a personal digital assistant, or any electronic device used by a minor and coupled to a wired or wireless network. According to 72, database 56 stores the information. In the event that minor system 46 becomes erased, damaged, or compromised, database 56 still provides a usage record from minor system 46.

According to 74, analytical module 60 analyzes the information indicative of the usage record. This analysis includes correlating the information to a particular risk profile and then making a decision as to a course of action to take based upon the particular risk profile. According to 76, analytical module 60 determines whether an alert is warranted and, if so, what type of alert is warranted. If an alert is warranted, notification module 64 transmits an alert according to 78. According to 78, the alert is transmitted to one or more of a parent system 48, a law enforcement system 50, another system 52, a personal computer, a laptop computer, a cellular phone, a land telephone, or an electronic device that is coupled to a wireless or wired network.

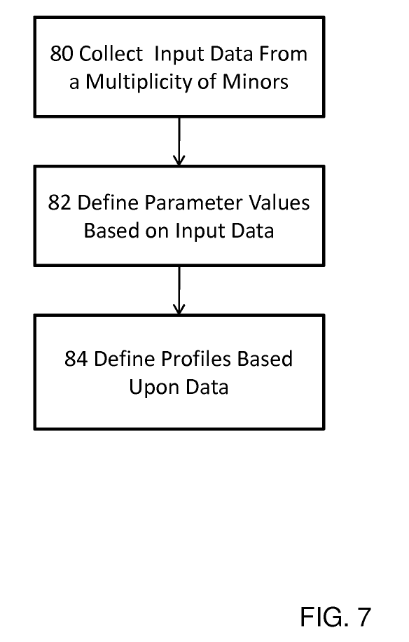

FIG. 7 depicts a method of defining risk profiles by correlating inputs received from reporting sources to particular risk profiles. According to 80, input data is received by monitoring module 58 for a large number of minors and stored in database 56. In one embodiment, this input data is based upon internet usage. This input data may also be based information from various reporting sources and may include non-internet behaviors or confirmed contacts by adult offenders.

According to 82, parameter value assigning module 60A converts the input data into parameter values for each minor. Each type of input may define a separate parameter value. Some parameter values may also be defined for multiple different types of inputs and may be indicative of relationships between or interactions between the original sources of different inputs.

According to 84, profile defining module 60B correlates particular risk profiles with the parameter values. In a preferred embodiment, this correlation is based on statistical methods such as statistical clustering methods.

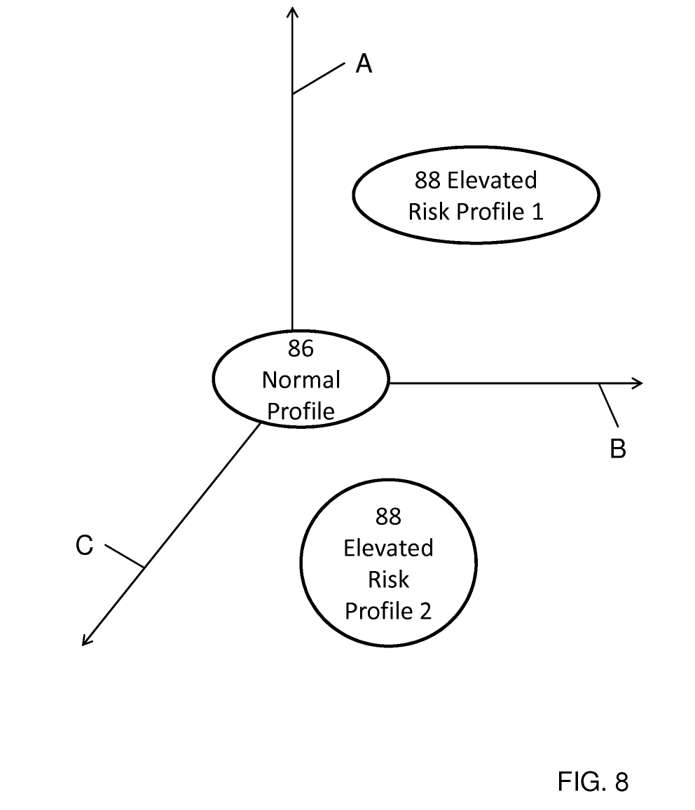

FIG. 8 depicts statistical clusters or groupings that may be a result of the method depicted in FIG. 7. Axes A, B, and C depict factors used for clustering. For example, axis A may depict a degree to which a minor uses words that might relate to self-destructive behavior. Axis B may depict a degree to which a minor accesses or attempts to access certain higher risk web sites. Axis C may depict a degree to which a minor communicates with an unidentified contact. In practice there are probably more than three factors; FIG. 8 depicts three factors for illustrative simplicity.

Three clusters are identified—a normal cluster 86 and elevated risk clusters 88. The normal cluster 86 would be indicative of a minor having a normal level of risk without a single major risk factor standing out. Elevated risk clusters 88 would be each be indicative of a combination of factors that are indicative high risk behavior. Clusters 88 define elevated risk profile 1 and elevated risk profile 2.

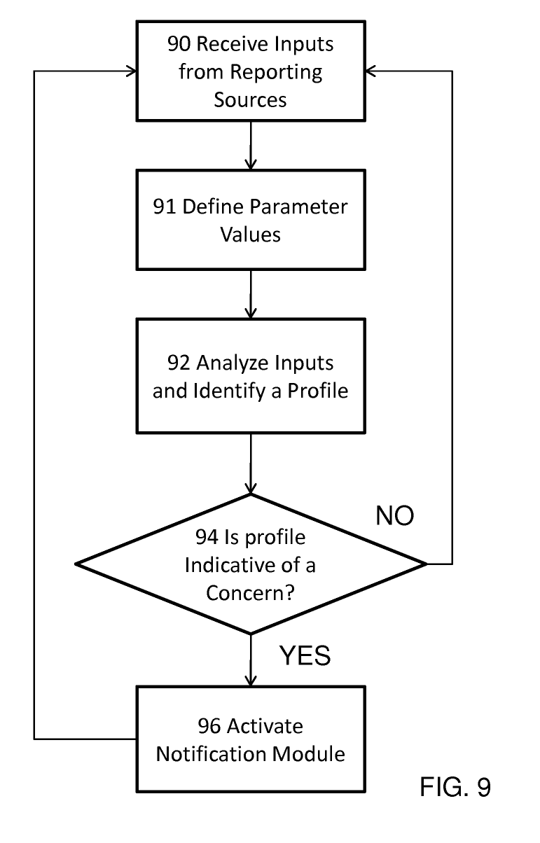

FIG. 9 depicts a method of determining and using a risk profile for a given minor to be utilized by IPSS 44. According to 90, monitoring module 58 receives inputs from various reporting sources, such as the minor's system 46. According to 91 the inputs are processed by parameter value assigning module 60A to define parameter values. According to 92, the parameter values are processed by profile fitting module 60C in order to select or update a risk profile for the minor. In one embodiment, this is done by fitting the parameter values to a statistical cluster.

According to 94, decision module 60D determines a course of recommended action based upon the minor's risk profile. If the risk profile is a “non-elevated” risk profile, then the process loops back to 90 and inputs continue to be received by monitoring module 58. On the other hand, if the risk profile indicates an elevated risk, the decision module 60D actives notification module 64 according to 96. According to 96, an alert or alarm may be generated. In one embodiment, the alert is generated by IPSS 44 and communicated to another device such as a parent system 48, a law enforcement system 50, another system 52, a telephone, a laptop computer, a desktop computer, a PDA a mobile device, or an electronic device that is coupled to a wired or wireless network.

### Reporting Sources:

As discussed supra, various reporting sources are monitored by parents 12, by integrated protection service 10, and/or by integrated protection service system 44. The reporting sources provide inputs that can then be analyzed to determine risk profiles and/or an appropriate response. The numbers indicated below indicate clusters 1-7 that are all clusters indicative of an elevated risk profile.

Inputs from Reporting Source Including One or More of Subject Child or Minor:

| Cluster | Input Information |
|---|---|
| 7 | Child reports receipt of unsolicited sexual email or photograph |
| 7 | Child reports receipt of unsolicited sexual instant |
| | message/instant communication |
| 7 | Child reports receipt of unsolicited mail from the United |
| | States Post Office |
| 7 | Child reports receipt of unsolicited contact via United States Post |
| | Office |
| 8 | Child reports receipt of unsolicited contact outside of the home |
| 8 | Child reports unsolicited sexual contact outside of home |
| 9 | Child reports observed sexual contact determined to be of |
| | an illegal nature |
| 9 | Child reports contact from a friend reporting sexual behavior |
| | of an illegal nature |
| 10 | Child reports sexual molest by a family member, parent, sibling, |
| | extended family member |
| 11 | Child reports sexual molest by a non related, but familiar |
| | adult, or child |
| 12 | Child reports sexual molest by an unknown person |

Inputs from Reporting Source Including One or More of Minor's Family or Parent or Guardian or Friends:

| Cluster | Input Information |
|---|---|
| 1, 2, 3, 4, 5 | Child begins spending inordinate amount of time on the computer. |
| 1, 2, 3, 6 | Child become secretive about computer activity (e.g. extensive |
| | password protection utilized by the child) |
| 1, 2, 3 | Child develops new and advanced skills operating the computer. |
| 1, 2, 3, 4, 6 | Increasing tendency to use the telephone, cell phone, web camera, |
| | text messaging while on the computer |
| 1 | Child begins withdrawing from family relationships and family |
| | intimacy. |
| 1 | Child withdraws from friends and social activities |
| 1 | The child's siblings will notice a behavioral change. |
| 1 | Child changes their social environment to include abandoning |
| | friends. |
| 1, 2, 6 | Child may exhibit a new interest in their appearance, or level of |
| | maturity. |
| 1 | The child may incorporate into their conversation new names of |
| | persons not previously known. |
| 1, 2, 3 | Child may receive unusual mail, or packages. |
| 1, 6 | The child may receive phone calls from individuals not known to the family |
| 1, 2, 3, 4 | Child may add, and install peripheral devices for the computer. |
| 1 | The child may display a new interest in technology |
| 1, 6 | The child may ask for a cell phone, new cell phone, or cell phone |
| | with specific features |
| 1 | The child may display an increase of interest in sexual matters, or |
| | become sexually active. |
| 1 | The child may act out sexually with siblings, family, or friends |
| 1, 4, 5, 6 | Child starts sleeping over away from home |
| 1, 4, 5, 6 | The child might obtain luggage, or travel items |

Inputs from Reporting Source Including One or More of Child's Friends, Classmates, or School

| Cluster | Input Information |
|---|---|
| 1, 2, 3, 4, 6 | Child displays increased use of phone, cell phone, |
| | text messaging, etc. |
| 1 | Child withdraws from activities, relationships |
| 1 | Child becomes secretive |
| 1, 2, 6 | Child changes appearance relating to sexual maturity |
| 1 | Child mentions names of friends not previously known |
| 1 | Child may express a new level of interest in technology |
| 1 | Child may act out in sexual manners, become more |
| | physically involved |
| 6 | Child is observed to be with friends not previously |
| | known nor from the local area |
| 1, 2, 3, 4, 5, 6 | Child may display, or be observed with new jewelry, or |
| | unexplained gifts |
| 1, 4, 5, 6 | Child's school work suffers, child disengages from |
| | academics |
| 1, 2, 3, 4, 5, 6 | Child's behavior may become aggressive, violent, |
| | belligerent |
| 1, 2, 3, 4, 5, 6 | Child may express a change in self image |

Inputs from Reporting Source Originating from Outside the Home, or Child's Known Environment

| Cluster | Input Information |
|---|---|
| 1, 2, 3 | Child is contacted by social services, law enforcement, or other |
| | government entity |
| 1, 5, 6 | Child is interviewed at school, or at home by law |
| | enforcement/child is a witness or victim |
| 1, 5, 6 | Child's identity becomes known by virtue of reporting by |
| | third party, investigation |
| 1, 5, 6 | Child is taken into custody |
| 1, 5, 6 | Child is admitted to a hospital |
| 1, 5, 6 | Child becomes missing to include running away |

Inputs from Reporting Source Including One of a Computer, Cell Phone, PDA, Laptop, Palmtop, or Other Device Accessed by a Minor:

| Cluster | Input Information |
|---|---|
| 1, 2, 3, 4 | Child may install new programs for purposes of protecting or |
| | destroying information |
| 1, 2, 3, 4 | Child may install new program providing enhanced communication ability |
| 1, 2, 3, 4 | Internet activity will develop an unexplained focus, or intensity |
| | toward certain Internet sites/chat rooms |
| 1, 2, 3, 4 | Additional Internet and computer activity toward downloading, |
| | uploading pictures, and video |
| 1, 2 | The child will obtain, or author stories and fantasies |
| 1, 2 | The child's stories and fantasies will incorporate themes of |
| | romance, and sexual encounters |
| 1, 2, 3, 4, 5, 6 | The child may develop new contacts with people not known to the |
| | child's family |
| 1, 2, 3 | A review of the computer may review a dramatic increase of |
| | pictures and videos |
| 1, 2, 3 | The computer may be configured for greater autonomy |
| 1, 2, 3 | Screen savers may change |
| 1, 2, 3, 4, 5, 6 | The child may follow a strict time regimen to be present at the |
| | computer at certain times |
| 1, 2, 3, 4 | There may be a dramatic increase in email, instant messaging, or |
| | message board participation |
| 1, 5, 6 | The child may begin tracking transportation services such as bus, |
| | train, or air schedules |
| 1, 5, 6 | There may be research about different areas of the country or |
| | countries |
| 1, 5, 6 | The child may initiate registrations on different travel related sites |

### Parameter Values

Described above are inputs received by monitoring module from various reporting sources. In order to allow the use of subsequent analytical techniques, the inputs need to be in a form that allows the software to have some form of digital or quantified information. Below are some examples of how parameter values may be assigned for various inputs. Note that these are exemplary only and will depend upon the profile-fitting software—what values it will accept and the required normalization.

Erasure Software Installed: 0=NO, 1=YES

Erasure Software Used: 0=NO, 1=YES

Number of Megabytes of Files Destroyed

MySpace Used: 0=NO, 1=YES

Communication with Unidentified Contact on MySpace: 0=NO, 1=YES

Unidentified Contact: 0=NO, 1=YES

Travel Destinations Discussed in Communication with Unknown Contact: 0=NO, 1=YES

Intimate Words/Phrases Used in Communication with Unknown Contact: 0=NO, 1=YES

Web Camera Used: 0=NO, 1=YES

Frequency of Web Camera Usage in Hours Per Week

Resolution of Web Camera Images in Megapixels

Average File Sizes of Web Camera Files

Type of Web Camera Content

Web Camera Files Sent to Unidentified Contact: 0=NO, 1=YES

### Elevated Risk Profiles:

Risk profiles are defined by type and magnitude. Below are some examples of types of risk profiles.

Depression/Suicide

High Risk and Imminent Danger (Take Immediate Action to Prevent)

Moderate Risk or Less Imminent (Take Longer Term Actions)

Abduction or Adult Offender Assaults

High Risk and/or Imminent Danger (Take Immediate Action to Prevent and Engage Law Enforcement)

Moderate Risk (Provide Counseling and Obtain Advice From Law Enforcement)

Undue Peer Pressure or Harassment

High Risk and/or Imminent

### Elevated Risk Profile Example 1—Depression/Suicide:

Below is an example of the parameter values for a high risk depression/suicide profile.

Minor frequents certain web sites correlating with depression: YES=1

Minor writes stories with phrases and words correlating with depression, death and suicide: YES=1

Percentage of stories incorporating words and phrases correlating with depression, death, and suicide: 92%

Minor's text communications with other minors incorporates phrases and words associated with depression, death, and suicide: YES=1

Percentage of communications having above: 57%

### Elevated Risk Profile Example 2—Adult Predator Risk:

Below is an example of the parameter values for a high risk adult predator profile:

Minor utilizes social networking and/or chat sites: YES=1

Minor communicates with unidentified contact: YES=1

Communications have sexual content: YES=1

Communications involve web camera: YES=1

1. A method of protecting a minor from threats comprising:
providing an integrated protection service system having monitoring and analysis functions;
automatically monitoring a reporting source that provides an input indicative of potential risks to the minor; and
automatically analyzing the input to determine a risk profile for the minor.

2. The method of claim 1 wherein the input is a plurality of inputs and further comprising: automatically assigning a plurality of parameter values based upon the plurality of inputs and wherein the risk profile is based upon the plurality of parameter values.

3. The method of claim 2 wherein at least one of the plurality of parameter values is based upon a correlation of two or more inputs.

4. The method of claim 2 wherein the risk profile is based upon identifying a statistical cluster based upon the plurality of parameter values.

5. The method of claim 2 wherein the risk profile is based upon where one or more of the plurality of parameter values has a particular range of values.

6. The method of claim 2 further comprising selecting a response based upon the risk profile.

7. The method of claim 6 wherein the response includes automatically passing an alert to one or more of a telephone, a computer, a cellular telephone, a laptop, a mobile electronic device, a fixed electronic device.

8. The method of claim 1 wherein the reporting source is a plurality of reporting sources that each provide at least one input indicative of potential risks to the minor.

9. An integrated protection service system for protecting a minor from various threats comprising:
a computer system having a plurality of software modules wherein the modules further comprise:
a monitoring module configured to receive inputs from a reporting source; and
an analytical module configured to analyze the inputs and to determine a risk profile indicative of a threat to the minor.

10. The integrated protection service system of claim 9 wherein the analytical module is configured to define a plurality of parameter values based upon the inputs, the plurality of parameter values define the risk profile.

11. The integrated protection service system of claim 9 wherein the analytical module is configured to define statistical clusters and wherein determining a risk profile includes selecting from among the statistical clusters.

12. The integrated protection system of claim 9 wherein the analytical module includes a plurality of profile fitting modules wherein each of the plurality of profile fitting modules utilizes a different process for determining risk profiles based upon the inputs.

13. The integrated protection service of claim 9 wherein the analytical module defines a plurality of different risk profiles and wherein determining a risk profile includes selecting one of the plurality of different risk profiles based upon the inputs.

14. The integrated protection service of claim 9 wherein the analytical function is configured to select a response from a plurality of responses based upon the risk profile.

15. A method of protecting minors from threats comprising:
providing an integrated protection service system including a computer system and a plurality of software modules;
defining a plurality of parameter values for each of the minors based upon inputs received from a reporting sources; and
defining a risk profile for each of the minors based upon the plurality of parameter values.

16. The method of claim 15 wherein each risk profile defines an associated statistical cluster of minors.

17. The method of claim 16 wherein each risk profile is based upon a statistical cluster analysis.

18. The method of claim 16 wherein each risk profile is based upon a threshold analysis of an associated plurality of parameter values.

19. The method of claim 15, further comprising, analyzing each risk profile to determine an appropriate course of action for each of the minors.

20. The method of claim 19 further comprising initiating a response based upon the appropriate course of action, initiating a response includes sending an alert to a plurality of different electronic devices.
